(19) United States
(12) Patent Application Publication
(10) Pub. No.: US 2008/0122382 A1
(43) Pub. Date: May 29, 2008

(54) Lighting System and Method

(76) Inventors: David Moriconi, Ben Lomond, CA (US); Robert Mariolo, Santa Cruz, CA (US); Glenn Stark, Scotts Valley, CA (US)

Correspondence Address: MARTINE PENILLA & GENCARELLA, LLP, 710 LAKEWAY DRIVE, SUITE 200, SUNNYVALE, CA, 94085, US

(21) Appl. No.: 11/945,908

(22) Filed: Nov. 27, 2007

Related U.S. Application Data
(60) Provisional application No. 60/861,533, filed on Nov. 27, 2006.

(51) Int. Cl. F21V 33/00; H05B 37/02

(52) U.S. Cl. 315/291; 362/577

(57) ABSTRACT

A light bar including a light pipe. The light pipe includes at least one substantially flat end, a substantially flat back surface and an emitting surface opposing the substantially flat back surface. The at least one substantially flat end is substantially polished. The substantially flat back side is substantially polished. The emitting surface being texturally diffused. The light bar also includes at least one light source proximate to at least one of the at least one substantially flat end. The least one light source emitting light at a first angle toward the substantially flat back surface.

### CROSS REFERENCE TO RELATED APPLICATIONS

This application claims priority from U.S. Provisional Patent Application No. 60/861,533 filed on Nov. 27, 2006 and entitled “Lighting System and Method,” which is incorporated herein by reference in its entirety.

### BACKGROUND

The present invention relates generally to lighting systems and methods for producing and using the lighting systems, and more particularly, to lighting systems and methods for various types of light bars and uses thereof including decorative and other functional uses such as a decorative or accent lighting on an umbrella or other decorative or accent surface (e.g., flooring, tables, walls, awnings, tents, signage or other temporary or permanent surfaces that may be fixed or portable).

Prior art lighted umbrellas typically require a battery or an external power source (e.g., typical power outlet and a cord to connect to the power outlet). Unfortunately, the battery powered lighted umbrella requires new batteries and/or recharging. Connecting a lighted umbrella to a power outlet limits their use to someplace near a power outlet and results in unsightly and even unsafe power cords.

On typical decorative lighting type is referred to as a Christmas-type light strand. The Christmas-type light strand is a strand of small lights along a common electrical conductor as may be used to decorate a Christmas tree or similar decorative applications. The Christmas-type light strand can used to form of various configurations including wrapping, outlining and even sculpting shapes. When used in an umbrella for example Christmas-type lights are typically strung along or around the multiple support arms of the umbrella. While decorative, the Christmas-type lights are lacking in that they provide very high intensity points of lights that are not conducive to a mellower mood that may be desired in a relaxing environment such as a restaurant or a private corner of a patio.

In view of the foregoing, there is a need for an improved decorative lighting system and method.

### SUMMARY

Broadly speaking, the present invention fills these needs by providing an improved decorative lighting systems and methods. It should be appreciated that the present invention can be implemented in numerous ways, including as a process, an apparatus, a system, computer readable media, or a device. Several inventive embodiments of the present invention are described below.

One embodiment provides a light bar including a light pipe. The light pipe includes at least one substantially flat end, a substantially flat back surface and an emitting surface opposing the substantially flat back surface. The at least one substantially flat end is substantially polished. The substantially flat back side is substantially polished. The emitting surface being texturally diffused. The light bar also includes at least one light source proximate to at least one of the at least one substantially flat end. The least one light source emitting light at a first angle toward the substantially flat back surface.

The light bar can also include a reflector, the reflector being secured to the back surface. The light source is separated from the corresponding end of the at least one end of the light bar by a selected distance. The first angle can be about 2.65 degrees.

Each one of the at least one light source can emit a different wavelength of light. The light bar can be included in an umbrella. The umbrella can include a solar power source coupled to the light bar.

The light bar can be coupled to a power supply. The power supply can include a controller and a boost power supply constant current device configured to provide a constant current to the at least one light source. The power supply can be coupled to a solar power source.

Another embodiment provides a power supply. The power supply includes a battery, a central processing unit (CPU) and a boost power supply constant current device. The boost power supply constant current device including a power supply input coupled to an output of the battery, a control input coupled to the CPU and an output coupled to a load. The power supply also includes logic for applying a battery voltage to a boost power supply and constant current device, logic for measuring an instantaneous output current of the output of the boost power supply and constant current device, logic for selecting voltage that determines a target output current level, and logic for adjusting a boost level of the boost power supply constant current device to output the constant target output current level. The power supply can also include a charge controller coupled to a power source and the battery.

The power source can be included within the power supply. The power source can be a solar power source.

Another embodiment provides a method of supplying a constant current. The method includes applying a battery voltage to a boost power supply and constant current device, coupling an output load to an output of the boost power supply and constant current device, measuring an instantaneous output current of the output of the boost power supply and constant current device, selecting voltage that determines a target output current level and outputting the constant target output current level.

The method can also include charging the battery. Charging the battery can include charging the battery with a solar power source.

Yet another embodiment provides a method of producing a variable color light. The method includes applying a first color of light to a first end of a light pipe and applying a second color of light to a second end of a light pipe. The light pipe including a first substantially flat end, a second substantially flat end, a substantially flat back surface, an emitting surface opposing the substantially flat back surface, a first light source proximate to the first substantially flat end and a second light source proximate to the second substantially flat end. The first substantially flat end, the second substantially flat end and the substantially flat back surface are substantially polished. The second substantially flat end is opposite the first substantially flat end. The emitting surface being texturally diffused. The first light source emitting light at a first angle toward the substantially flat back surface. The second light source emitting light at a second angle toward the substantially flat back surface. The first light source emits a first color of light and wherein the second light source emits a second color of light. The method also includes transmitting the first color light along the length of the light pipe from the first end of the light pipe, transmitting the second color light along the length of the light pipe from the second end of the light pipe, mixing the first color and the second color for form a third color of light in a third portion of the light bar, emitting the third color of light from the third portion of the light bar. The third portion of the light bar is substantially centered in the light bar.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings.

FIG. 1A is a light bar, in accordance with an embodiment of the present invention.

FIGS. 1B and 1C are exploded views of the light bar, in accordance with an embodiment of the present invention.

FIG. 2A is a top view of the light bar, in accordance with an embodiment of the present invention.

FIG. 2B is a detailed top view of the light source, in accordance with an embodiment of the present invention.

FIG. 3A is a side view of the light bar, in accordance with an embodiment of the present invention.

FIG. 3B is a detailed side view of the light source, in accordance with an embodiment of the present invention.

FIG. 3C illustrates a detailed side view of a portion of the light bar, in accordance with an embodiment of the present invention.

FIG. 3D illustrates a light bar, in accordance with an embodiment of the present invention.

FIG. 3E is a flowchart of the method operations of transmitting one or more colors of light through the light bar, in accordance with an embodiment of the present invention.

FIG. 4A is a block diagram of a power supply, in accordance with an embodiment of the present invention.

FIG. 4B is a schematic diagram of the power supply, in accordance with an embodiment of the present invention.

FIG. 4C is a flowchart of the method operations of the power supply, in accordance with an embodiment of the present invention.

FIGS. 5A-C show an umbrella frame including the power supply, in accordance with at least one embodiment of the present invention.

### DETAILED DESCRIPTION

Several exemplary embodiments for improved decorative lighting systems and methods will now be described. It will be apparent to those skilled in the art that the present invention may be practiced without some or all of the specific details set forth herein.

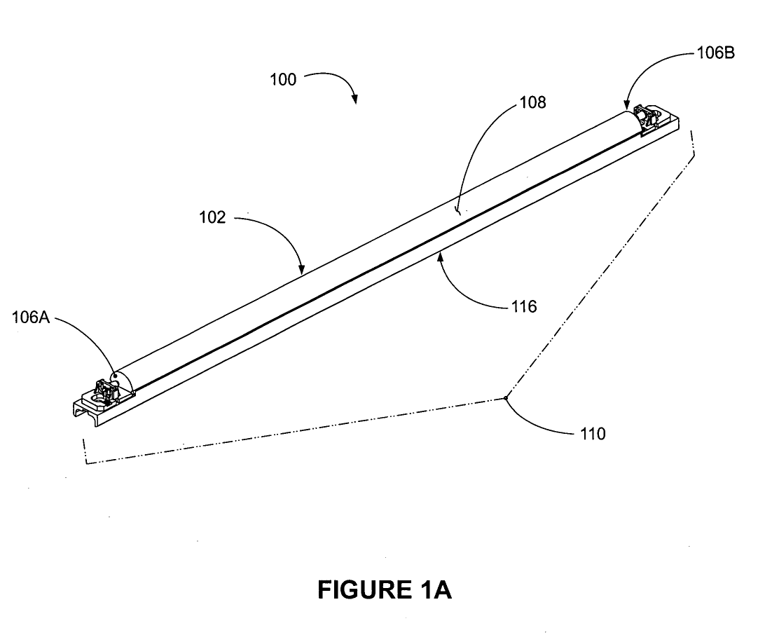

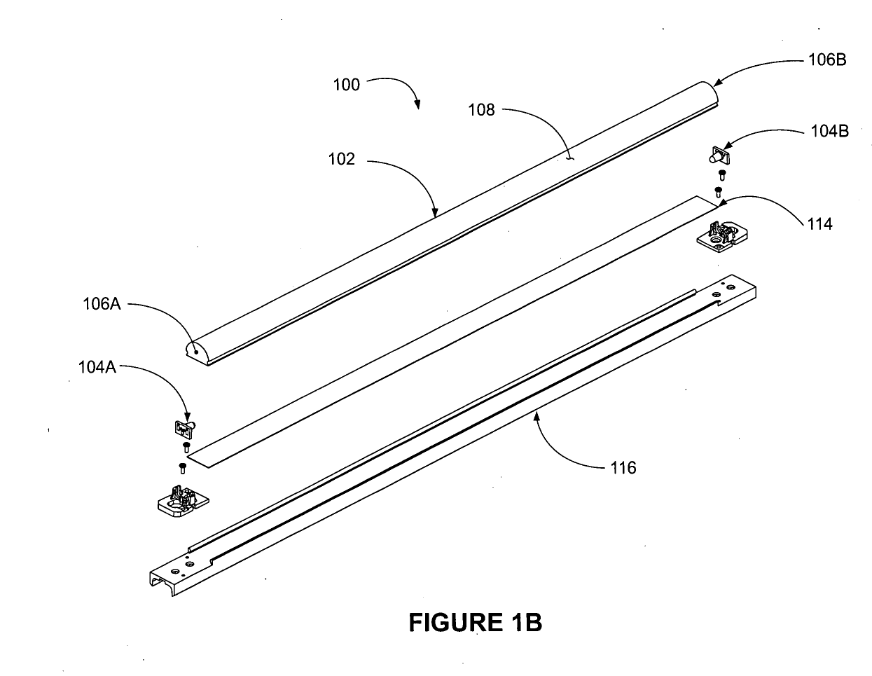

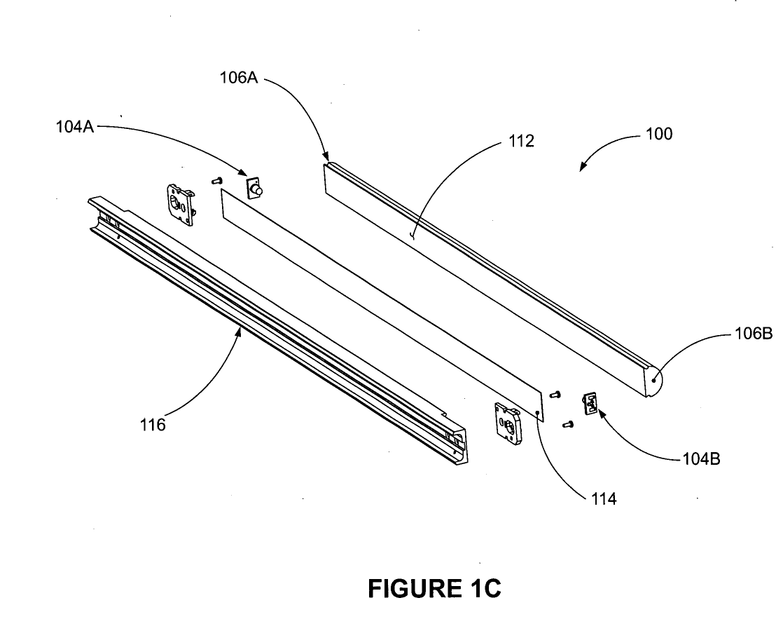

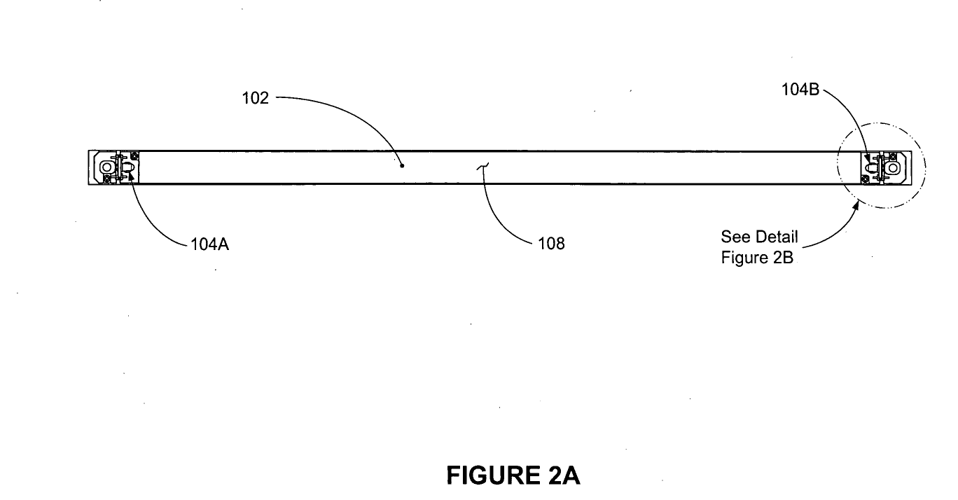

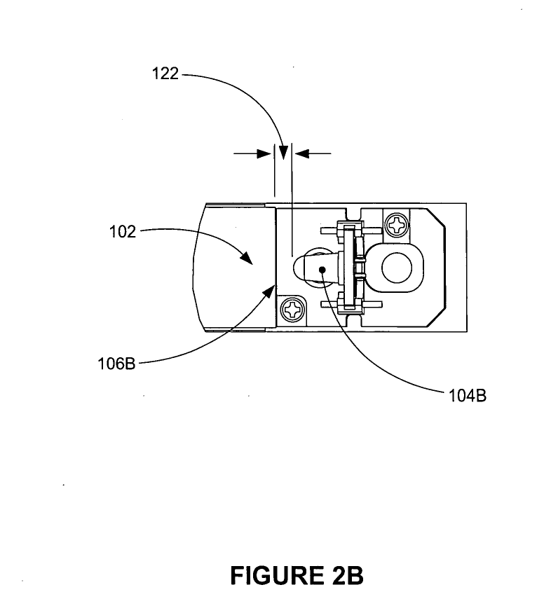

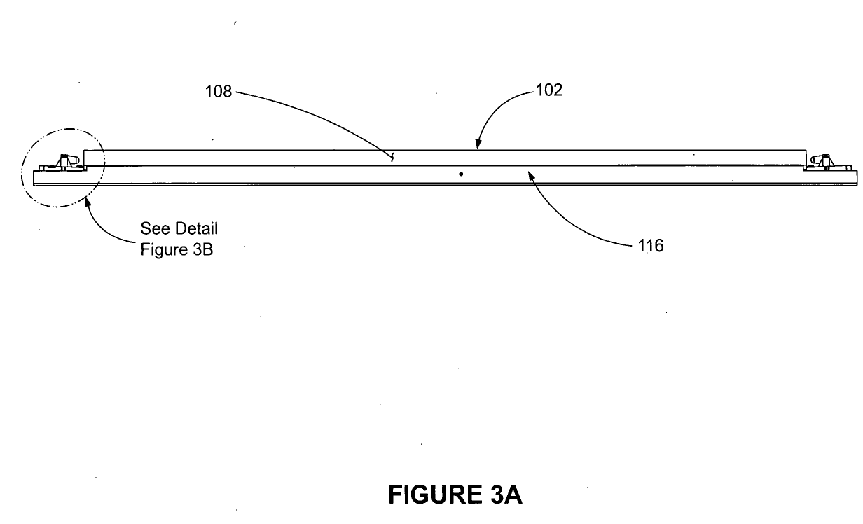

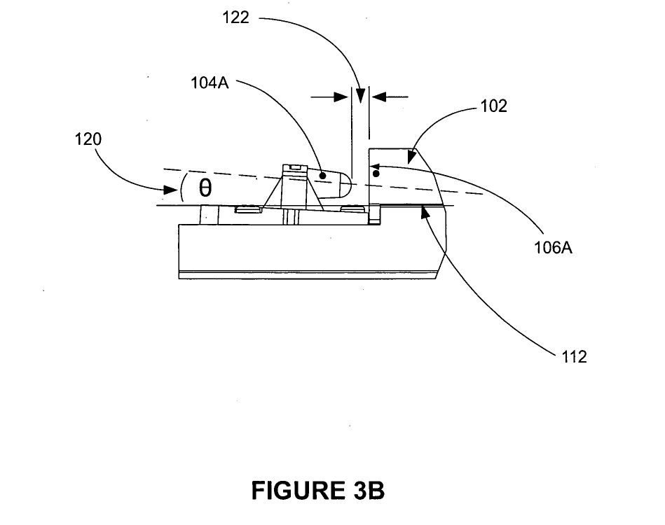

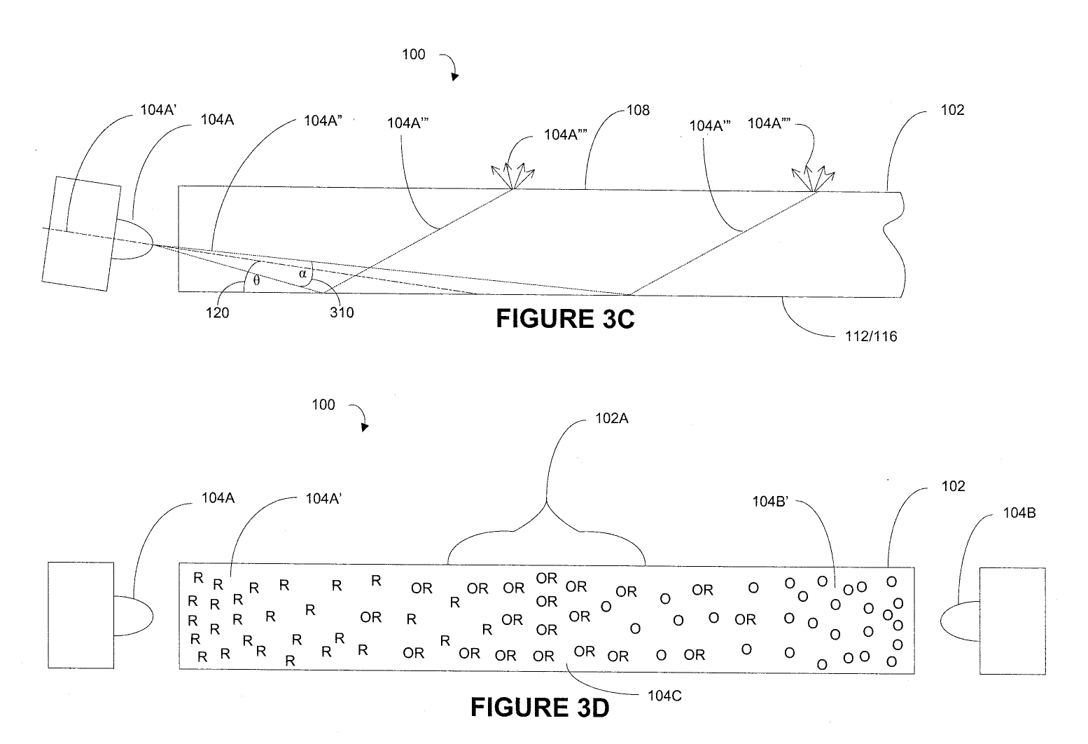

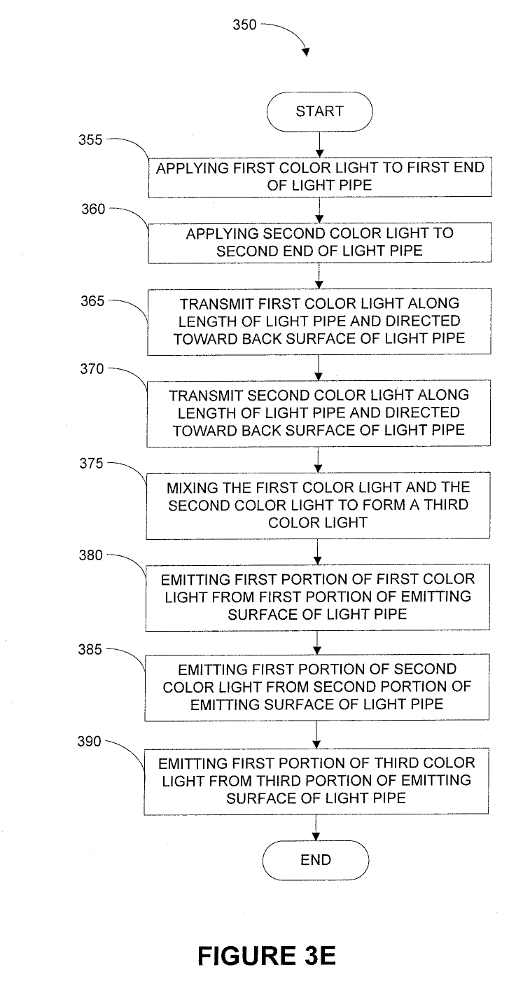

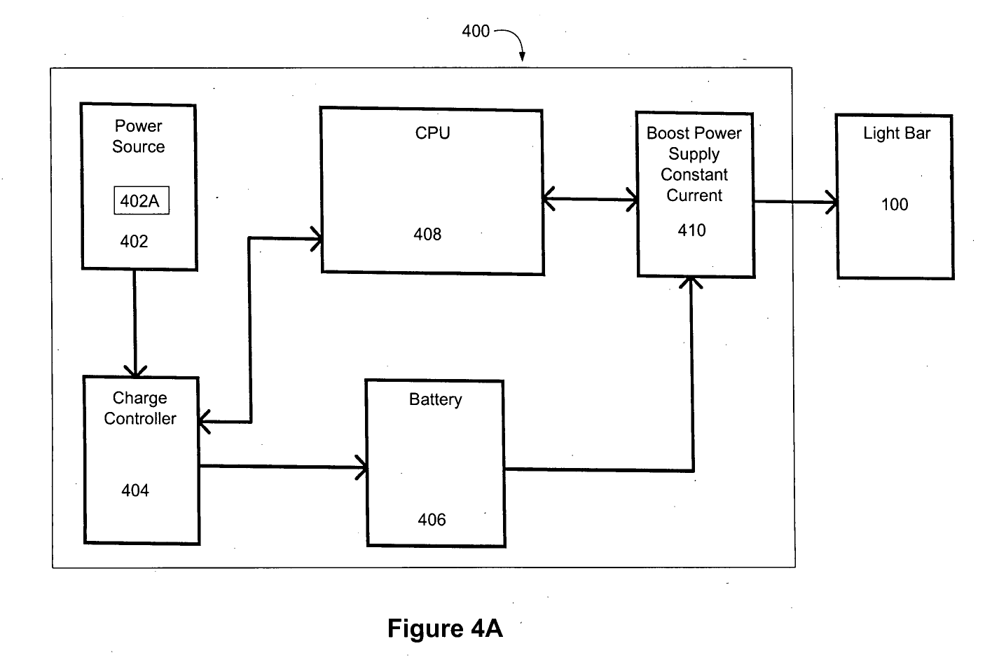

FIG. 1A is a light bar 100, in accordance with an embodiment of the present invention. FIGS. 1B and 1C are exploded views of the light bar 100, in accordance with an embodiment of the present invention. FIG. 2A is a top view of the light bar 100, in accordance with an embodiment of the present invention. FIG. 2B is a detailed top view of the light source 104B, in accordance with an embodiment of the present invention. FIG. 3A is a side view of the light bar 100, in accordance with an embodiment of the present invention. FIG. 3B is a detailed side view of the light source 104A, in accordance with an embodiment of the present invention.

The light bar 100 includes a light pipe 102. The light pipe 102 can be any suitable cross-sectional shape and dimension. By way of example, the light pipe 102 can have a cross-sectional shape of a half-round or D-shape as shown at the end 106A of the light pipe. While not illustrated the light pipe 102 can also be formed with a rectangular or a parabolic cross-sectional shape. The light pipe 102 can be any suitable transparent material (e.g., glass, plastic, crystal, etc.). The light bar 100 of a selected length 110.

The light bar 100 also includes at least one light source 104A, 104B at corresponding ends 106A, 106B of the light pipe 102. The light source 104A, 104B can emit light in one or more colors. The light source 104A, 104B can be any suitable type of light source (e.g., light emitting diode, laser, incandescent, fluorescent, etc.). Each of the light sources 104A, 104B emit light into corresponding ends of the light pipe 106A, 106B.

The outer surface 108 of the light pipe 102 can be rounded, flat, faceted or have multiple contours such as raised ribs and depressed channels that are either curved or straight along the length of the light pipe. The outer surface 108 of the light pipe 102 can also have decorative designs formed therein.

The outer surface 108 of the light pipe 102 can be texturally diffused. In one embodiment, the surface 108 is texturally diffused by random abrasion of a selected media and a selected depth. The textural diffusion causes the reflecting internal light rays to exit the light pipe 102 in random directions resulting in the appearance of the glowing light pipe 102 in a manner reminiscent of a soft neon tube. The diffused finish of the outer surface 108 can be a bead blast finish such as a number 6-24 dry blast. The diffused finish of the outer surface 108 can be any suitable finish that may be chosen for a selected application. The diffused finish of the outer surface 108 can be matched to a sample.

The light pipe 102 also includes a back surface 112. The back surface 112 of the light pipe 102 and the two ends 106A, 106B are highly polished, substantially flat surfaces. The high polish of the back surface and the ends 106A, 106B can be defined as a Society of Plastics Industry standard finish of A1 to A3 finish. The A1 finish being a highly polished mirror-like finish.

The polished ends 106A, 106B are substantially perpendicular to the flat, polished back surface 112. The polished ends 106A, 106B allow the light rays from the light sources 104A, 104B to enter the light pipe 102 in a manner that causes the light rays to be contained by, and reflected internally by the polished back surface 112, thereby reflecting the majority of the light rays emitted for the light sources 104A, 104B lengthwise down the light pipe 102. The light rays emitted for the light sources 104A, 104B reflect varying distances along the light bar 102 until the light ray contacts the diffused outer surface 108 and is emitted through the outer surface.

The transmission of light along the length of the light pipe 102 is enhanced by multiple factors. One factor is that the light source 104A, 104B at either end 106A, 106B is directed at a slight angle θ 120 toward the back surface 112. FIG. 3C illustrates a detailed side view of a portion of the light bar 100, in accordance with an embodiment of the present invention. The light source 104A is shown however, the light source 104B is substantially similar at the opposing end of the light pipe 102. The light source 104A emits light along a center line 104A′. The light source 104A can also emit light in a spread pattern 104A″ about center line 104A′. The spread pattern can have an angle α 310. The angle α 310 can be between less than about 1 degree up to about 20 degrees. <inventors is this a good range?> The angle θ 120 of the light source 104A, 104B relative to a centerline 104A′ of the light source can be any angle sufficient to cause the emitted light to impinge on the back surface 112. By way of example the angle θ 120 can be 2.65 degrees. The light along the center line 104A′ or the spread pattern 104A″ can reflect off of the back surface 112 toward the emitting surface 108. When the reflected light 104A′″ impinges on the emitting surface 108, at least a portion 104A″″ of the light 104A′″ is emitted from the emitting surface 108.

A second factor enhancing the transmission of light along the length of the light pipe 102 is the spacing 122 between the polished end 106A, 106B and respective light source 104A, 104B. By way of example the spacing 122 can be between less than 1 mm to greater than about 10 mm. <Inventors is that range good?>

Another factor is the use of a reflector 114. The reflector 114 can be any suitable color or combination of colors (e.g., white, red, blue, yellow, green, polished metal, mirror finish, or any other suitable reflective finish or combination of finishes). The reflector 114 is secured to the back surface 112. The reflectors 114 can be positioned and held in place by a structural frame 116. The structural frame 116 can be formed in any shape suitable for the application of the light bar 100.

The light sources 104A, 104B can be any suitable light emitting source. By way of example, the light sources 104A, 104B can be incandescent bulbs, fluorescent bulbs, halogen bulbs, laser diodes or light emitting diodes and combinations thereof.

FIG. 3D illustrates a light bar 100, in accordance with an embodiment of the present invention. FIG. 3E is a flowchart of the method operations 350 of transmitting one or more colors of light through the light bar, in accordance with an embodiment of the present invention. In operations 355 and 360, respectively, light sources 104A, 104B can emit different colors of light at the corresponding opposing ends 106A, 106B of the light pipe 102. In operations 365 and 370, respectively, the light sources 104A, 104B can transmit different colors of light at the corresponding opposing ends 106A, 106B of the light pipe 102 down the length of the light pipe. In operation 375, the first color light and the second color light combine to from a third color of light. In operation 380, a first portion of the first color light is emitted from a first portion of the emitting surface 108 of the light pipe 102. In operation 385, a first portion of the second color light is emitted from a second portion of the emitting surface 108 of the light pipe 102. In operation 390, a first portion of the third color light is emitted from a third portion of the emitting surface 108 of the light pipe 102. As the different color light rays traverse the length of the light pipe 102, the different colors can diminish a perception of light intensity loss near the center portion of the light pipe 102. The intensity loss can be obscured by the change in hue as the two colors of light blend continuously from one end 106A of the light pipe 102 to the other end 106B.

In one exemplary embodiment, the light source 104A can emit a red light 104A′ and light source 104B can emit a yellow light 104B′. The respective ends 106A, 106B of the light pipe will emit light from the light pipe 102 be substantially red light 104A′ or yellow light 104B′ respectively. However, as the light 104A′, 104B′ traverses the light pipe 102 from the respective ends 106A, 106B toward a center portion 102A, the light colors 104A′, 104B′ mix to create a rich orange hue 104C that is emitted around the center portion of the light bar 102. While red and yellow light are described herein this is merely an exemplary embodiment. The light sources 104A, 104B can be the same or any colors as may be desired.

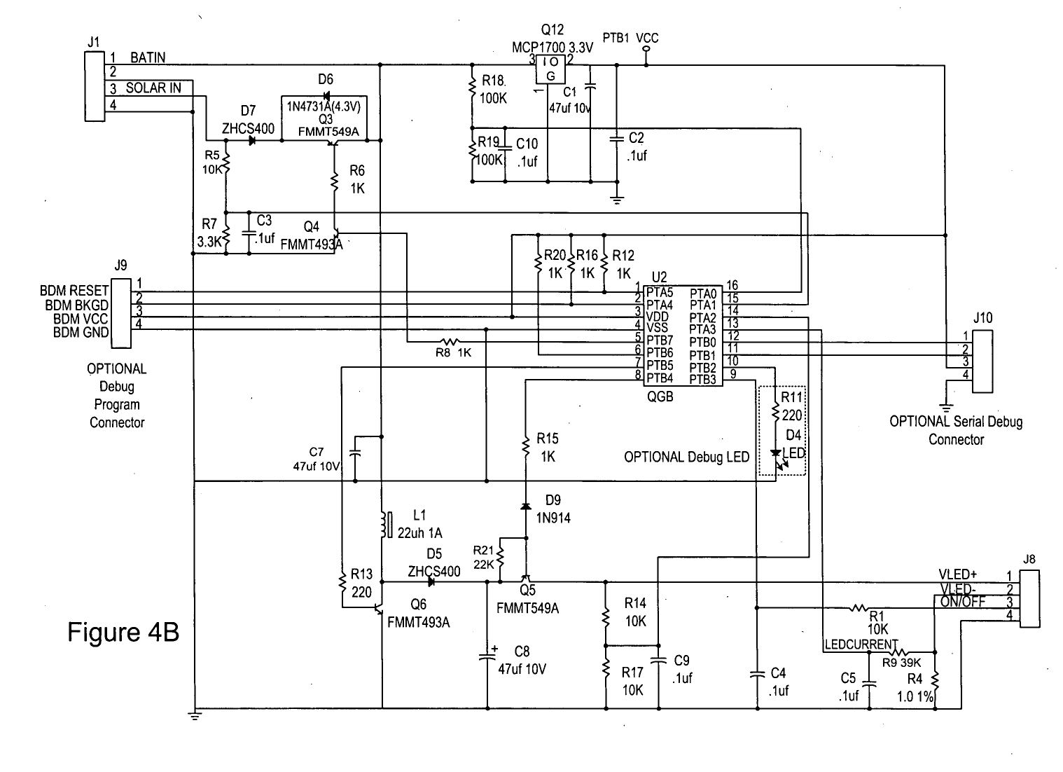

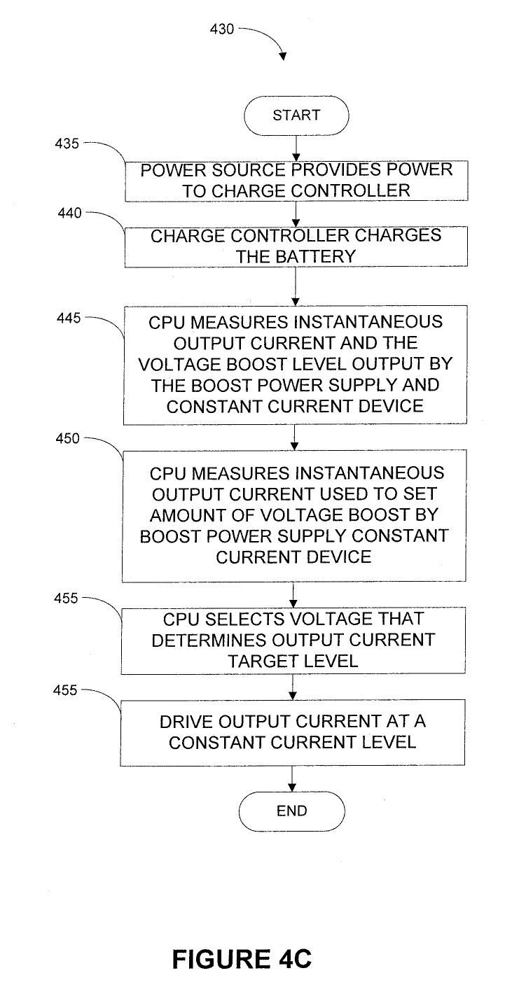

FIG. 4A is a block diagram of a power supply 400, in accordance with an embodiment of the present invention. FIG. 4B is a schematic diagram of the power supply 400, in accordance with an embodiment of the present invention. The power supply 400 includes a power source 402 coupled to a charge controller 404. The charge controller 404 is coupled to an electrical power storage device 406 and a central processing unit (CPU) 408. The storage device 406 is coupled to and provides electrical power to a boost power supply constant current device 410. The CPU 408 is also coupled to and controls the boost power supply constant current device 410. The boost power supply constant current device 410 is coupled to a consuming device e.g., the light bar 100.

The power source 402 can be any suitable power source including one or more of a battery, a solar power panel, power from a typical outlet (i.e., 110/220 volts AC). The power source 402 can include a solar panel 402A.

The electrical power storage device 406 can be any suitable storage device or combination of storage devices including batteries, capacitors, etc.

The CPU 408 includes an analog to digital converter (A/D) and a pulse width modulator (PWM). The A/D is used to measure the instantaneous output current and the voltage boost level output by the boost power supply and constant current device 410. The PWM drives the voltage boost directly at about 20 kHz or any suitable frequency up to about 100 kHz). The duty cycle controls the boost level produced by the boost power supply and constant current device 410.

The boost power supply constant current device 410 provides a constant current to the output (e.g., the light bar 100). The boost power supply constant current device 410 is very helpful when the light bar 100 includes one or more light emitting diodes. The CPU 408 detects the LED current using a resistor and the analog to digital converter (A/D). The LED current information is used to set the PWM that controls the boost power supply constant current device 410. The CPU 408 thereby controls the voltage that determines the LED current target of 160 mA. This allows the battery 406 to drive the LEDs at a substantially constant 160 mA regardless of the actual battery voltage level. The boost power supply constant current device 410 uses an inductor that measures the LED current to control the voltage, resulting in an average 160 mA current.

FIG. 4C is a flowchart of the method operations 430 of the power supply 400, in accordance with an embodiment of the present invention. In an operation 435, the power source 402 provides power to the charge controller 404. By way of example, the solar panel 402A receives ambient light and converts the ambient light into electrical current.

In an operation 440, the charge controller 504 receives the electrical current from the power source 402 and charges the battery 406.

In an operation 445, the CPU 408 measures the instantaneous output current and the voltage boost level output by the boost power supply and constant current device 410. In an operation 450, the measured instantaneous output current is used to set the pulse width modulator that controls the boost power supply constant current device 410. A proportional integrating differentiator method is used in the PCU 408 to control the pulse width modulator.

In an operation 455, the CPU 408 selects the voltage that determines the output current target. This allows the battery 406 to drive the output current at a substantially constant current level regardless of the actual battery voltage level in an operation 460.

By way of example, the boost power supply constant current device 410 takes the 4.2 v to 3.4 v output from the battery 406 and boosts the battery voltage to the required voltage that will drive the output current to the LEDs in the light sources 104A, 104B with the target 160 mA drive current.

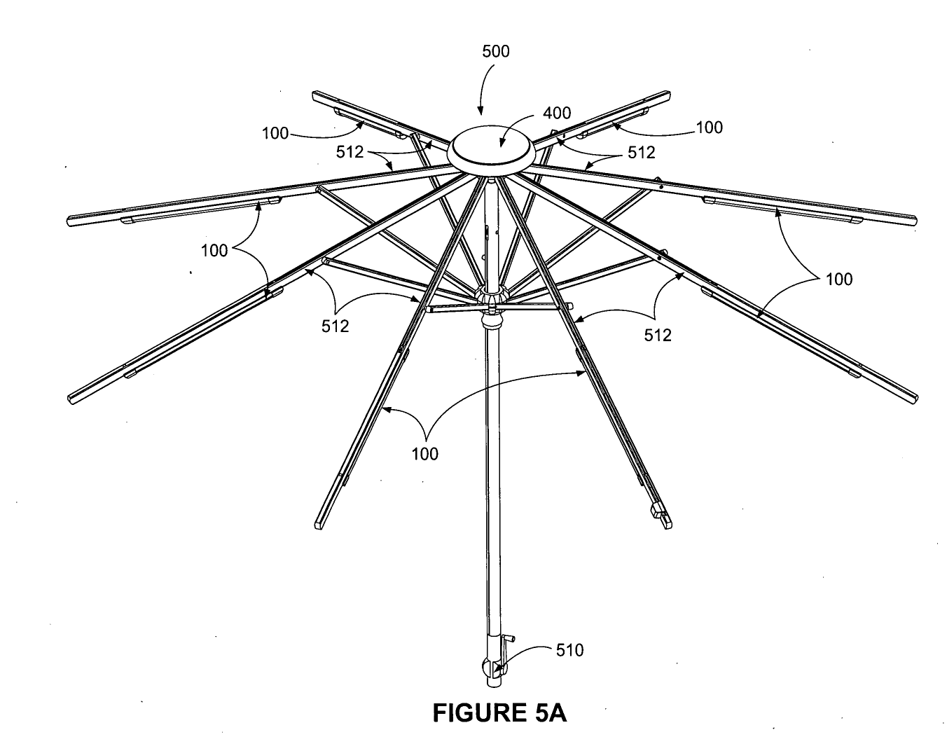

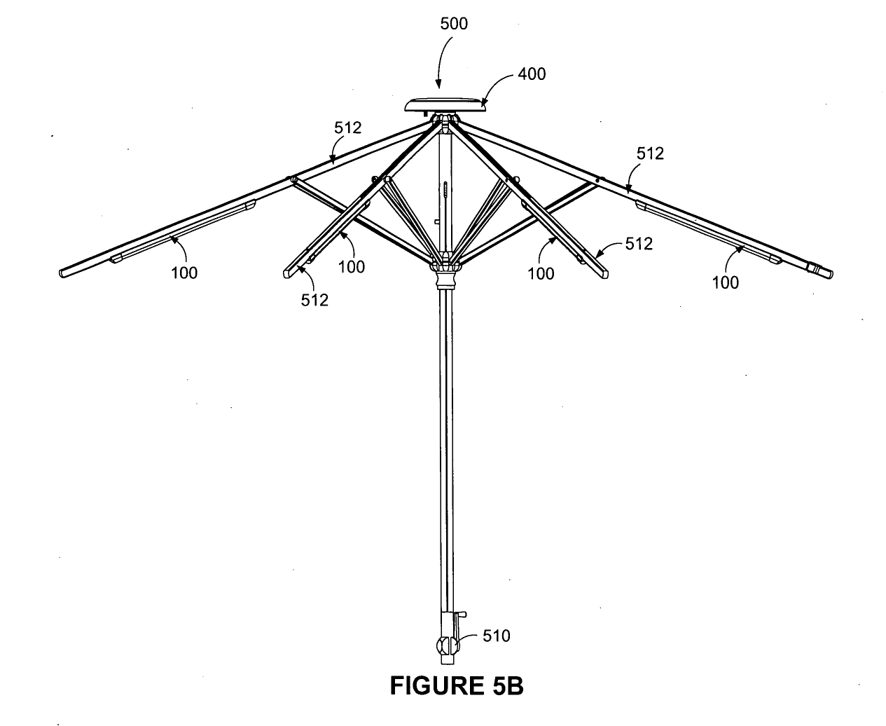

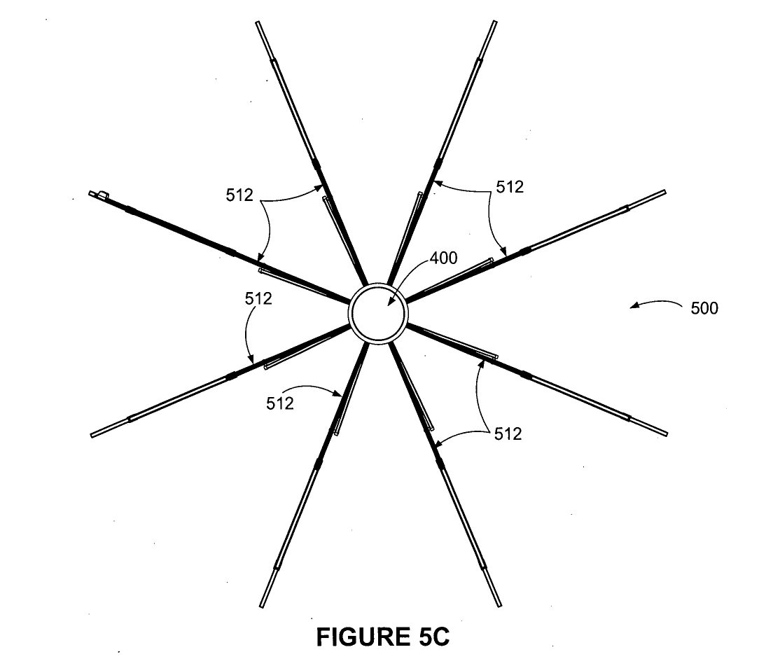

FIGS. 5A-C show an umbrella frame 500 including the power supply 100, in accordance with at least one embodiment of the present invention. The umbrella frame 500 includes a light bar 100 and a power supply 400 coupled to the light bar. The umbrella 500 can be portable (e.g., hand carried, beach or golf umbrella). The umbrella 500 can be fixed (e.g., a patio, market or table umbrella). The umbrella 500 can be powered by an internal power source (e.g., battery) or a solar power source or an external power source (e.g., any alternating or direct current source of suitable voltage and current capabilities).

The umbrella 500 can function during the day as a normal market umbrella. In the evening the umbrella 500 can provide specialty lighting that creates a very special ambience for the customer. The lighting emitted from the light bar 100 can be a constant, soothing color and intensity. The lighting emitted from the light bar 100 can also be varying colors and intensities. By way of example, in a romantic setting, constant or relatively slowly changing, soft, red glow might be preferable. The red glow might slowly vary and intensity and/or relatively slowly change to another color. Alternatively, in a dance club, the lighting can be varying colors and intensities to coordinate with the music to enhance the lively nature of the environment.

In one exemplary embodiment, the umbrella 500 has a width or diameter of about 2.7 meter (9-foot), however, the umbrella can be any size or shape. The umbrella 500 can include a covering that can be any selected color and any suitable material (e.g., natural and artificial fiber fabrics or canvas, plastic, fiberglass, etc.). The lighting bar 100 can include multiple settings to allow a user to select a desired operating mode (i.e., select desired colors, intensities, changing rates, etc.).

The umbrella 500 can also include a power supply 400 with a solar panel 402 to power the light bar(s) 100. The solar powered umbrella does not require electrical connections to any outside power source. This provides complete portability to the customer and is virtually maintenance free.

The umbrella 500 can also include an easy to use hand crank system 510 that allows a user to either open or close the umbrella at the turn of a crank handle. The positive positioning crank handle system is ideal when using the umbrella 500 through the center of a table or other support.

The umbrella 500 can include one or more light bars 100. The light bars 100 can be installed one or more to each of one or more of the structural members 512 of the umbrella. Each of the light bars 100 can be individually controlled. Alternatively, the light bars 100 can be electrically coupled together so as to allow the light bars to be controlled by a single controller.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the described embodiments.

What is claimed is:

1. A light bar comprising:
a light pipe including:
at least one substantially flat end, wherein the at least one substantially flat end is substantially polished;
a substantially flat back surface, wherein the substantially flat back side is substantially polished; and
an emitting surface opposing the substantially flat back surface, the emitting surface being texturally diffused; and
at least one light source proximate to at least one of the at least one substantially flat end, the least one light source emitting light at a first angle toward the substantially flat back surface.

2. The light bar of claim 1, further comprising a reflector, the reflector being secured to the back surface

3. The light bar of claim 1, wherein the light source is separated from the corresponding end of the at least one end of the light bar by a selected distance.

4. The light bar of claim 1, wherein first angle is about 2.65 degrees.

5. The light bar of claim 1, wherein each one of the at least one light source emits a different wavelength of light.

6. The light bar of claim 1, wherein the light bar is included in an umbrella.

7. The light bar of claim 6, wherein the umbrella includes a solar power source coupled to the light bar.

8. The light bar of claim 1, wherein the light bar is coupled to a power supply, the power supply including a controller and a boost power supply constant current device configured to provide a constant current to the at least one light source.

9. The light bar of claim 8, wherein the power supply is coupled to a solar power source.

10. A power supply comprising:
a battery;
a central processing unit (CPU);
a boost power supply constant current device including:
a power supply input coupled to an output of the battery;
a control input coupled to the CPU; and
an output coupled to a load;
logic for applying a battery voltage to a boost power supply and constant current device;
logic for measuring an instantaneous output current of the output of the boost power supply and constant current device;
logic for selecting voltage that determines a target output current level; and
logic for adjusting a boost level of the boost power supply constant current device to output the constant target output current level.

11. The power supply of claim 10, further comprising a charge controller coupled to a power source and the battery.

12. The power supply of claim 11, wherein the power source is included within the power supply.

13. The power supply of claim 12, wherein the power source is a solar power source.

14. A method of supplying a constant current comprising:
applying a battery voltage to a boost power supply and constant current device;
coupling an output load to an output of the boost power supply and constant current device;
measuring an instantaneous output current of the output of the boost power supply and constant current device;
selecting voltage that determines a target output current level; and
outputting the constant target output current level.

15. The method of claim 14, further comprising charging the battery.

16. The method of claim 15, wherein charging the battery includes charging the battery with a solar power source.

17. A method of producing a variable color light comprising:
applying a first color of light to a first end of a light pipe and applying a second color of light to a second end of a light pipe, the light pipe including:
a first substantially flat end, wherein the first substantially flat end is substantially polished;
a second substantially flat end, wherein the second substantially flat end is substantially polished and wherein the second substantially flat end is opposite the first substantially flat end;
a substantially flat back surface, wherein the substantially flat back side is substantially polished; and
an emitting surface opposing the substantially flat back surface, the emitting surface being texturally diffused;
a first light source proximate to the first substantially flat end, the first light source emitting light at a first angle toward the substantially flat back surface; and
a second light source proximate to the second substantially flat end, the second light source emitting light at a second angle toward the substantially flat back surface; wherein the first light source emits a first color of light and wherein the second light source emits a second color of light;
transmitting the first color light along the length of the light pipe from the first end of the light pipe;
transmitting the second color light along the length of the light pipe from the second end of the light pipe;
mixing the first color and the second color for form a third color of light in a third portion of the light bar; and
emitting the third color of light from the third portion of the light bar, wherein the third portion of the light bar is substantially centered in the light bar.
